(19) United States
(12) Patent Application Publication
(10) Pub. No.: US 2006/0092833 A1
(43) Pub. Date: May 4, 2006

(54) Congestion control for improved management of service level agreements in switched networks

(76) Inventors: Jeroen van Bemmel, Leiden (NL); Arie Johannes Heer, Hengelo (NL); Richa Malhotra, Enschede (NL)

Correspondence Address: Lucent Technologies Inc.;Docket Administrator, Room 3J-219, 101 Crawfords Corner Road, Holmdel, NJ, 07733-3030, US

(21) Appl. No.: 10/979,349

(22) Filed: Nov. 2, 2004

(51) Int. Cl. H04L 12/26; H04L 1/00

(52) U.S. Cl. 370/229

(57) ABSTRACT

When a switch in a switched network detects congestion at one of its inputs, it floods a congestion control message back to the ingress nodes of the network connected to that input, indicating congestion. The ingress nodes of the network restrict access to the network by comparing incoming information rates against customer-specific criteria and sending back pressure warning signals to respective customers when the criteria are exceeded. When an ingress node receives a congestion control message indicating congestion it changes the criteria by which it restricts access to the network to more restrictive criteria. When the switch detects that the congestion has subsided, it floods a further congestion control message to the ingress nodes connected to the input, indicating that the congestion has subsided. An ingress node receiving such a message then changes the criteria back to those which it normally applies.

### TECHNICAL FIELD

This invention is related to methods and apparatus for managing service level agreements (SLAs) in switched networks, such as switched Ethernet networks.

### BACKGROUND OF THE INVENTION

An advantage of Ethernet (or IEEE 802.3) networks is their simplicity and low cost. This has led to wide acceptance of the standard (or standards) and a desire to extend it from local area networks (LAN) to metropolitan area networks (MAN) and even to wide area networks (WAN). For such an expansion to be practical, the network needs to be able to provide various qualities of service as required by various customers and to meet service level agreements.

From the point of view of a network operator, a problem with SLAs is to police them, or, in other words, to make sure that customers do not overload the system by sending much more traffic over the network than the agreed amount. Then, the network can be provisioned to accommodate the agreed levels of traffic. When it becomes necessary, because of congestion in the network, packets are dropped, but the operator needs to be able to ensure, in so far as it is possible, that packets are not dropped which are in compliance with a customer's SLA. On the other hand, the operator will wish to accommodate traffic in excess of a customer's SLA when it is possible to do so without adversely affecting the ability to meet the SLAs of other customers.

Policing of SLAs is normally done by having, for each customer, a committed information rate (CIR) and a peak information rate (PIR). Generally speaking, the idea is to guarantee packets within the CIR and to try and accommodate packets up to the PIR whenever possible. Generally this is done by using a “token bucket” algorithm or a “leaky bucket” algorithm, which classifies and marks packets according to whether they are within the CIR, exceed the CIR but are within the PIR, or exceed the PIR. On the basis of such classification and marking, congestion control measures can be taken. The aim of such congestion measures would be to ensure that, in times of congestion, only marked packets are dropped and un-marked packets pass through.

The problem remains, how to take advantage of the statistical gain afforded by networks such as Ethernet networks whilst making sure that, even when the network is congested, transport of packets within customers' CIRs is guaranteed in so far as it is possible; that is to say, how to ensure that in times of congestion, only marked packets are dropped.

One possibility might be to treat all traffic that exceeds a CIR as “best effort” traffic and place it in a low priority queue. Packets in the low priority queue could then be dropped in times of congestion. This, however, has the disadvantage that it could lead to mis-ordered packets. In particular, it would not work for an Ethernet network.

Another possibility might be to have thresholds on queues in the network, and, when the threshold is exceeded, to allow only those packets that are within their CIR to enter the queue, dropping the others. This, however, would not guarantee that all packets within their CIR would be allowed, since the queue would already contain packets marked as not complying, and they would be allowed to remain.

Another possibility might be to ensure that in times of congestion, packets marked as exceeding their CIR are dropped before any others. This, however, would mean that packets would have to be dropped from within a queue. Most switches and routers uses a fist-in-first-out (FIFO) structure for their input and output buffers, which means that operations have to be carried out at the head or the tail of the queue. Enabling packets to be deleted from within a queue would mean that this FIFO structure, which is simple to implement and maintain, and guarantees packet ordering, could no longer be used. Thus, a considerable increase in complexity would be involved.

Furthermore, all of these possibilities have the disadvantage that they work by dropping packets, which can affect end-user traffic streams. CIR is a crude measure of quality of service, and a congestion control system that works exclusively by dropping packets runs the risk that, while customers receive their CIR, the end users, with higher-layer applications, do not receive their desired quality of service. For example, a single end-user application flow could include both marked and un-marked packets at the ingress to a MAN, owing to aggregation of many such flows. It is better to introduce flow controls to restrict access to the network and thus to minimize the necessity of dropping packets from within the network. In addition, the change in restriction should preferably be communicated to the customer access network which can further limit the number of ongoing end-user flows.

### SUMMARY OF THE INVENTION

According to one aspect of an embodiment of the invention a method carried out at a node of a switched network comprises monitoring an input of said node to detect a congestion state and upon detecting the congestion state, flooding a congestion control message indicating congestion to all ingress nodes of said network that are connected to said input.

According to a further aspect of an embodiment of the invention a method carried out at an ingress node of a switched network comprises monitoring customer data rates for data entering the network, comparing said customer data rates against first customer-specific criteria, upon a customer's data rate exceeding a respective criterion, sending a back pressure warning signal to said customer and upon receipt of a congestion control message indicating congestion within the network, changing said criteria to second criteria, more restrictive than said first criteria.

According to a further aspect of an embodiment of the invention a node for use in a switched network comprises means for monitoring an input of said node to detect a congestion state and means responsive to detection of the congestion state, for flooding a congestion control message indicating congestion to all ingress nodes of said network that are connected to said input.

According to a further aspect of an embodiment of the invention apparatus for use in an ingress node of a switched network comprises means for monitoring customer data rates for data entering the network and comparing said customer data rates against first customer-specific criteria, means responsive to a customer's data rate exceeding a respective criterion for sending a back pressure warning signal to said customer and means responsive to receipt of a congestion control message indicating congestion within the network for changing said criteria to second criteria, more restrictive than said first criteria.

In an exemplary embodiment of the invention, when a switch detects congestion at one of its inputs, it floods a congestion control message back to the ingress points of the network connected to that input, indicating congestion. An ingress node receiving such a message then changes the criteria by which it restricts access to the network. For example it may limit traffic to traffic within its CIR only, or, if it implements a CIR and a PIR, it may do so more restrictively, by reducing the traffic admitted which exceeds its CIR. for example, it may adopt an effective PIR which is less than the normal PIR, such as PIR*=½(PIR+CIR) or, more generally, PIR*=αPIR+(1−α)CIR where α<1. When the switch detects that the congestion has subsided, it floods a further congestion control message to the ingress points connected to the input, indicating that the congestion has subsided. An ingress node receiving such a message then changes the criteria back to those which it normally applies.

### BRIEF DESCRIPTION OF THE DRAWING

Some embodiments of the invention will now be described by way of example with reference to the accompanying drawings, in which:

FIG. 1 shows a simple metropolitan network in which the present invention may be practiced;

FIG. 2 shows a known policing arrangement at an ingress port of a network;

FIG. 3 shows a known anti-congestion arrangement at an input port of a node;

FIG. 4 shows another known policing arrangement at an ingress port of a network, arranged to restrict access to the network;

FIG. 5 shows, in conceptual form, a meter for a policing arrangement as shown in FIG. 4;

FIG. 6 shows an anti-congestion arrangement at an input port of a node which embodies the present invention;

FIG. 7 shows a policing arrangement at an ingress port of a network which embodies the present invention;

FIG. 8 shows, in conceptual form, a meter for a policing arrangement as shown in FIG. 7; and

FIG. 9 shows, in conceptual form, an alternative meter for a policing arrangement as shown in FIG. 7.

### DETAILED DESCRIPTION

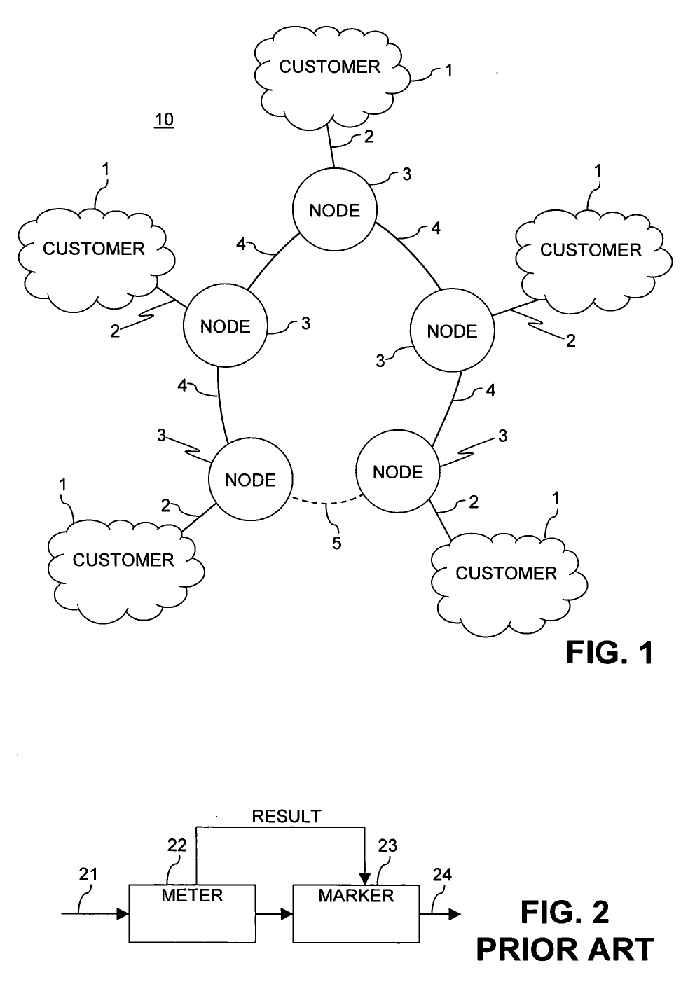

FIG. 1 shows an Ethernet metropolitan area network (MAN) 10 interconnecting customer sites 1. Each customer site 1 is connected via an ingress/egress link 2 to a node 3 of the network 10. The nodes 3 are interconnected by internal links 4. A further internal link 5 is also present but, as the network 10 is currently configured, is not used, because the spanning tree algorithm, which is a well-known part of the Ethernet standard, sets up the nodes to route packets via a subset of the links which constitute a spanning tree of the network, meaning that each node is connected to each other node by one unique path, and there are no loops. Such an arrangement provides redundancy, so that if one of the links 4 goes out of service, the network can reconfigure itself by running the spanning tree algorithm once again to set up a new spanning tree that does not included the out-of-service link.

The network shown in FIG. 1 is a simple one. It is possible for more than one customer 1 to be connected to the same node 3 by respective ingress/egress links, and it is possible for a network to include internal nodes that are not directly connected to any customer. The topology of a network may be such that a plurality of links are excluded by the spanning tree algorithm.

FIG. 2 shows a policing arrangement at an ingress port of a node 3 of FIG. 1. A packet stream 21 from a customer is applied to a meter 22 which tests the packet stream against criteria such as peak information rate PIR, committed information rate CIR and their associated burst sizes. The packet stream and the results of the tests are applied to a marker 23 which marks the packets to provide a marked packet stream 24. The marking of the packets is conventionally termed “green”, “yellow” or “red”. If a packet exceeds the PIR allotted to the customer the packet is marked “red”. If it does not exceed the CIR it is marked “green”. Otherwise, it is marked “yellow”. Details of an exemplary marking scheme will become apparent from the discussion below with reference to FIG. 5. The markings of the packets indicate the priority they should be afforded according to the customer's SLA.

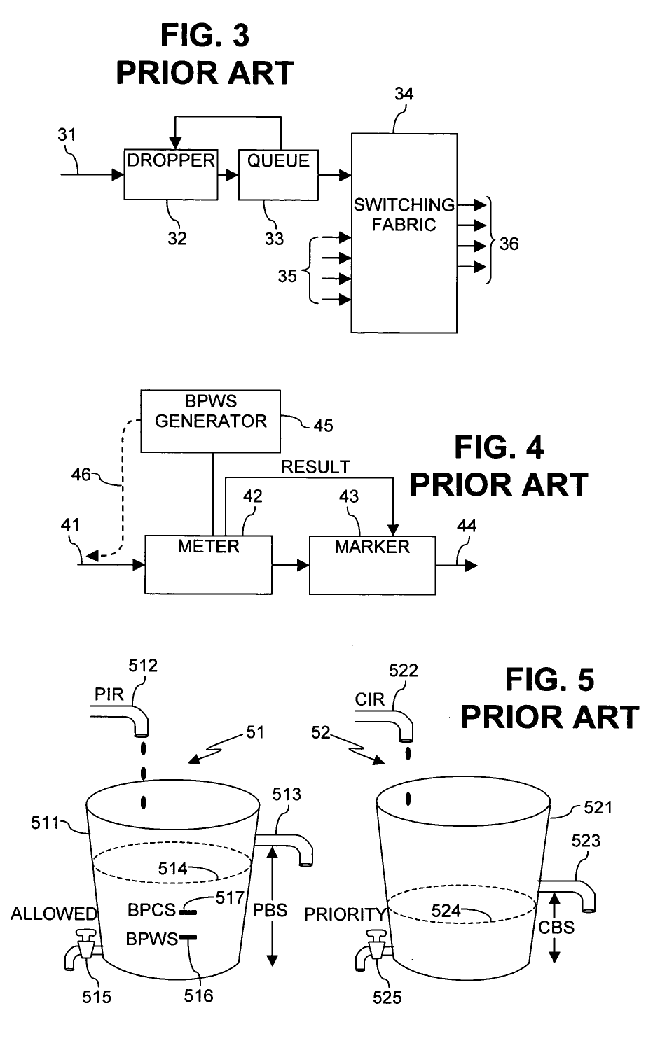

FIG. 3 shows a known arrangement at an input 31 of a switching node. The marked packet stream received at the input 31 is applied to a dropper 32 before being supplied to a queue 33 at an input to a switching fabric 34. Information about the state of the queue is supplied to the dropper, indicating whether the length of the queue exceeds a threshold, thus showing signs of congestion. The dropper 32 drops packets marked “red” from the packet stream and, if the threshold is exceeded, also drops packets marked “yellow”. Thus, the packets that were in excess of the customer's PIR are dropped whether or not the switch is congested, and those that are within the PIR, but exceed the CIR are dropped if the switch is congested. If the queue is actually full, no further packets can be added, so all packets are dropped, regardless of their marking.

Similar dropper and queue arrangements may be included in other inputs 35 to the switching fabric 34, and in the outputs 36.

The arrangement of FIG. 3 protects the switch against congestion, but does so exclusively by dropping packets. It applies a priority criterion, so that “green” packets are less likely to be dropped than “yellow” packets, and “red” packets are always dropped anyway, but since, once they are in the queue 33, packets are safe from being dropped, whatever their “color”, it is still possible that “green” packets will be dropped while “yellow” packets that are already waiting in the queue are kept.

FIG. 4 shows an arrangement which is a variant of the arrangement of FIG. 2 to restrict access to the network so that fewer packets need to be dropped. Such an arrangement is described in US Patent Application, publication no. US 2002/0031091 of van Everdingen. In this arrangement, as well as providing the result of the comparison tests to the marker 43, the meter 42 tests the information rate against a threshold and, where the threshold is exceeded, applies a signal to a back pressure warning signal (BPWS) generator 54, which sends a BPWS 46 back to the customer. The BPWS may take the form of an Ethernet PAUSE frame or, in the case of a half-duplex connection, may consist of a pre-emptive signal continuously applied to the connection, thus preventing further access because of the carrier sensing multiple access with collision detection (CSMA/CD) protocol. The BPWS signal may include a time-to-wait value indicating the length of the interval during which further packets are not to be sent, and/or it may be followed, when the meter 42 indicates that the information rate from the customer has sufficiently subsided, by a back pressure clearance signal (BPCS) indicating that transmission of packets may be resumed. In the case of an Ethernet PAUSE frame, such a frame includes a time field which indicates the time-to-wait value, and a BPCS may consist of a further PAUSE frame with the time field indicating a time-to-wait value of zero. With this arrangement, when the meter shows that the information rate is in danger of exceeding the agreed PIR, so that packets are likely to be dropped, access to the network is restricted. Thus, the necessity for packets to be dropped is reduced somewhat. However, congestion may still occur at switches within the network, and packets may still have to be dropped.

FIG. 5 illustrates, in conceptual form an algorithm which may be used by the meter 42. The algorithm is implemented electronically, by means of counters, which may exist as discrete components or as software components, but such algorithms are frequently described as “token bucket” algorithms and the bucket analogy, which provides a useful intuitive view of the algorithm, is used in FIG. 5 and in the following description.

The algorithm consists of two parts, 51 and 52. The first part 51 tests the information rate against the PIR and the second part 52 tests it against the CIR. The first part 51 maintains a first token bucket (counter) 511 into which tokens are added at a rate determined by the PIR, represented by the first input pipe 512. The first token bucket 511 has a maximum capacity of PBS, represented by the first overflow pipe 513, which allows a maximum burst size within the PIR. At the start, the first token bucket 511 is full. When a packet of length B arrives, the level 514 in the first token bucket 511 is examined, and if it is less than B, the packet is marked “red”. If the level 514 is greater than or equal to B, B tokens are removed from the bucket, as represented by the first outlet tap 515. In this case, the packet is allowed, and is marked “yellow” or “green” depending on the result of the second part 52 of the algorithm.

The second part 52 of the algorithm maintains a second token bucket 521 into which tokens are added at a rate determined by the CIR, represented by the second input pipe 522. The second token bucket has a maximum capacity of CBS, represented by the second overflow pipe 523. At the start the second token bucket 521 is full. When a packet of length B arrives, the level 524 in the second token bucket 521 is examined, and if it is greater than or equal to B, the packet is marked “green” and B tokens are removed from the bucket, as represented by the second outlet tap 525. If it is less than B, and the packet is allowed by the first part 51 of the algorithm, the packet is marked “yellow”.

As so far described, the algorithm is as described by the Internet Engineering Task Force (IETF) request for comment (RFC) number 2698 ‘A Two Rate Three Color Marker’ by J. Heinanen and R. Guerin for an arrangement as shown in FIG. 2. For use in an arrangement as shown in FIG. 4, it is modified in that the first token bucket has two thresholds, a BPWS threshold 516 and a BPCS threshold 517. When the level 514 in the first token bucket 511 falls below the BPWS threshold 516 the meter 42 sends a signal to the BPWS generator 45 causing it to send a BPWS signal back to the customer. Then, when the level 514 reaches the BPCS threshold 517 the meter 42 sends a signal to the BPWS generator causing it to send a BPCS signal to the customer or, in the case of a half-duplex connection, to stop sending a continuous pre-emptive BPWS signal.

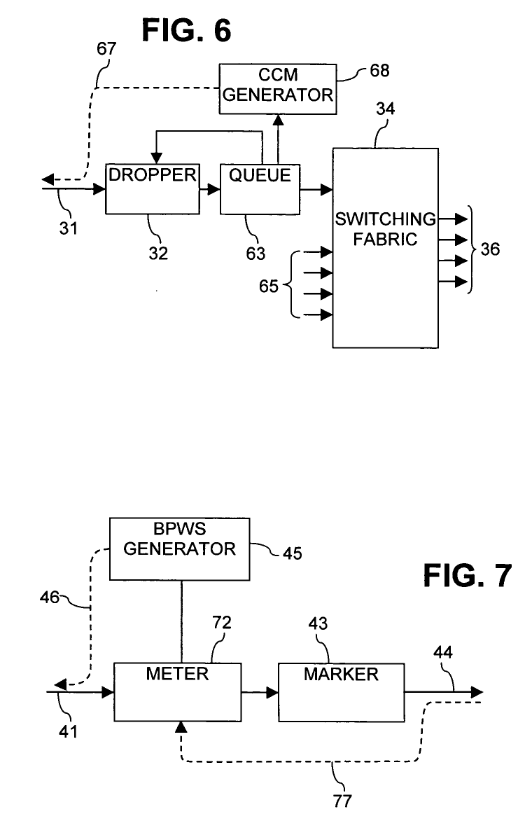

FIG. 6 shows a modification of the arrangement of FIG. 3, and illustrates one embodiment of the present invention. In addition to the packet dropping function described with reference to FIG. 3, when the length of the queue reaches a threshold a special congestion control message (CCM) 67 produced by a CCM generator 68 is flooded back to all the ingress points of the network connected to the input 31 indicating a congestion state. When the queue length falls below a second threshold, the CCM generator 68 floods a further special CCM indicating the end of the congestion state. It is important to note that the CCMs are flooded; they are not, like the BPWSs of the arrangement of FIG. 4, point-to-point signals.

FIG. 7 shows a modification of the arrangement of FIG. 4 at an ingress point of the network, and illustrates another embodiment of the invention. The meter 72 is arranged to respond to the receipt of a CCM 77 from within the network by modifying the algorithm which it executes so as to restrict access to the network according to stricter criteria. The BPWS arrangement as it is used at an ingress point of the network obviates in any case the need for a “red” classification of packets; the BPWS is used to prevent packets in excess of the PIR from being sent to the network. With the stricter criteria, the BPWS is used also to restrict access to the network for at least some packets in excess of the CIR but within the PIR during periods of congestion.

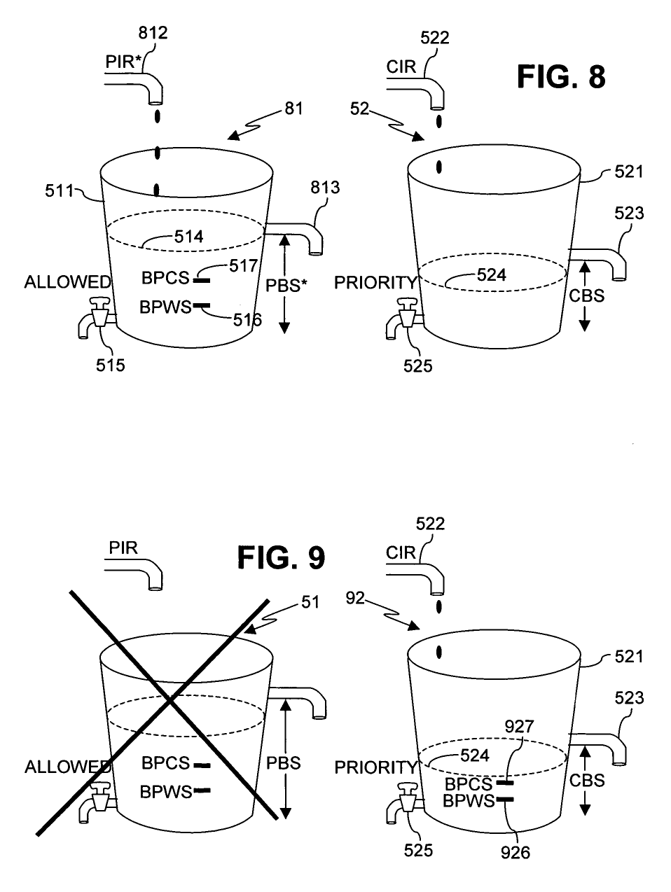

FIG. 8 shows one modification of the algorithm of FIG. 5 to apply stricter criteria according to another embodiment of the invention. As shown in FIG. 8, the first part 81 of the algorithm is modified so that the rate at which tokens are added to the first bucket 511 is reduced from the rate determined by the PIR as illustrated by the input pipe 512 of FIG. 5 to a lower rate determined by a modified PIR, PIR* as illustrated by the input pipe 812 of FIG. 8. Also, preferably, the maximum level of the first bucket 511 is reduced from PBS to a lesser value PBS* as illustrated by the overflow pipe 813. The criteria applied by the first part 81 of the algorithm are still less strict than those applied by the second part 52, but they are stricter than those applied by the first part 51 of the unmodified algorithm of FIG. 5. As an example, PIR* may be given by PIR*=½(PIR+CIR) or, more generally, PIR*=αPIR+(1−α)CIR where α<1.

FIG. 9 shows an alternative modification of the algorithm of FIG. 5 according to another embodiment of the invention which applies stricter criteria. As shown in FIG. 9 the first part 51 of the algorithm is no longer used (it is shown as being crossed out). Instead, packets are only admitted if they satisfy the CIR criterion. In this case, the second part 92 of the algorithm is modified in that BPWS and BPCS thresholds 926, 927 are applied to the level 524 in the second token bucket 521.

In the claims hereof, any element expressed as a means for performing a specified function is intended to encompass any way of performing that function including, for example, a) a combination of circuit elements which performs that function or b) software in any form, including firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent to those shown herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method carried out at a node of a switched network comprising:
monitoring an input of said node to detect a congestion state; and
upon detecting the congestion state, flooding a congestion control message indicating congestion to all ingress nodes of said network that are connected to said input.

2. The method of claim 1 wherein said monitoring comprises monitoring the length of a queue at said input.

3. The method of claim 2 wherein said monitoring comprises comparing the length of the queue with a threshold.

4. The method of claim 1 comprising continuing to monitor said input to detect the end of the congestion state and, upon detecting the end of the congestion state, flooding a congestion control message indicating the end of congestion to all said ingress nodes.

5. The method of claim 3 comprising continuing to monitor said queue by comparing the length of said queue with a second threshold to detect the end of the congestion state and, upon detecting the end of the congestion state, flooding a congestion control message indicating the end of congestion to all said ingress nodes.

6. A method carried out at an ingress node of a switched network comprising:
monitoring customer data rates for data entering the network, comparing said customer data rates against first customer-specific criteria;
upon a customer's data rate exceeding a respective criterion, sending a back pressure warning signal to said customer; and
upon receipt of a congestion control message indicating congestion within the network, changing said criteria to second criteria, more restrictive than said first criteria.

7. The method of claim 6 wherein said first criteria comprise a committed information rate and a permitted information rate, greater than the committed information rate, and wherein said second criteria comprise only said committed information rate.

8. The method of claim 6 wherein said first criteria comprise a committed information rate and a first permitted information rate, greater than the committed information rate, and wherein said second criteria comprise said committed information rate and a second permitted information rate, less than the first permitted information rate but greater than the committed information rate.

9. The method of claim 8 wherein said first criteria also comprise a first permitted burst size and said second criteria comprise a second permitted burst size, lower than the first permitted burst size.

10. A method of operating a switched network comprising:
monitoring inputs of nodes of the network to detect congestion states;
monitoring customer data rates for data entering the network at ingress nodes of the network;
comparing said customer data rates against first customer-specific criteria;
upon a customer's data rate exceeding a respective criterion, sending a back pressure warning signal to said customer;
upon detecting a congestion state at an input of a node, flooding a congestion control message indicating congestion to all ingress nodes of said network that are connected to said input; and
upon receipt at an ingress node of a congestion control message indicating congestion within the network, changing the criteria applied at said ingress node to second criteria, more restrictive than said first criteria.

11. A node for use in a switched network comprising:
means for monitoring an input of said node to detect a congestion state; and
means responsive to detection of the congestion state, for flooding a congestion control message indicating congestion to all ingress nodes of said network that are connected to said input.

12. The node of claim 11 wherein said monitoring comprises monitoring the length of a queue at said input.

13. The node of claim 12 wherein said monitoring comprises comparing the length of the queue with a threshold.

14. The node of claim 11 wherein said monitoring means is arranged to continue to monitor said input to detect the end of the congestion state and said flooding means is responsive to detection of the end of the congestion state for flooding a congestion control message indicating the end of congestion to all said ingress nodes.

15. The node of claim 13 wherein said monitoring means is arranged to continue to monitor said queue by comparing the length of said queue with a second threshold to detect the end of the congestion state and said flooding means is responsive to detection of the end of the congestion state for flooding a congestion control message indicating the end of congestion to all said ingress nodes.

16. Apparatus for use in an ingress node of a switched network comprising:
means for monitoring customer data rates for data entering the network and comparing said customer data rates against first customer-specific criteria;
means responsive to a customer's data rate exceeding a respective criterion for sending a back pressure warning signal to said customer; and
means responsive to receipt of a congestion control message indicating congestion within the network for changing said criteria to second criteria, more restrictive than said first criteria.

17. The apparatus of claim 16 wherein said first criteria comprise a committed information rate and a permitted information rate, greater than the committed information rate, and wherein said second criteria comprise only said committed information rate.

18. The apparatus of claim 16 wherein said first criteria comprise a committed information rate and a first permitted information rate, greater than the committed information rate, and wherein said second criteria comprise said committed information rate and a second permitted information rate, less than the first permitted information rate but greater than the committed information rate.

19. The apparatus of claim 18 wherein said first criteria also comprise a first permitted burst size and said second criteria comprise a second permitted burst size, lower than the first permitted burst size.
